(19) United States
(12) Patent Application Publication
(10) Pub. No.: US 2012/0132374 A1
(43) Pub. Date: May 31, 2012

(54) INSULATED GLASS WITH INTEGRAL BLIND - MANUALLY CONTROLLABLE

(76) Inventor: Wan-Ho Lee, Seoul (KR)

(21) Appl. No.: 13/378,191

(22) PCT Filed: Jun. 11, 2010
(86) PCT No.: PCT/KR2010/003789

§ 371 Date: Feb. 7, 2012

(30) Foreign Application Priority Data
Jun. 15, 2009 (KR) 10-2009-0053010
May 10, 2010 (KR) 10-2010-0043643

(51) Int. Cl. E06B 9/264

(52) U.S. Cl. 160/98

(57) ABSTRACT

A sealed blind for a double window is provided. A double window is installed in a frame formed by upper, lower and side frames in which an inner glass plate and an outer glass plate are installed spaced apart by a predetermined interval. A blind is installed inside the double window. An elevating shaft is connected to the blind and is configured to wind and unwind the blind. A sealed rotating unit is configured to rotate the elevating shaft. A first side of the rotating unit is installed in the elevating shaft and a second side of the rotating unit is disposed at an outer side of the side frame of the double window, such that outside air and dust are not introduced. An elevating wire is wound around the rotating unit and is configured to operate the rotating unit.

### CROSS-REFERENCE TO RELATED APPLICATION

This application is the U.S. National Phase of PCT/KR2010/003789, filed Jun. 11, 2010, and claims priority of Korean Patent Application No. 10-2009-0053010, filed on Jun. 15, 2009, and Korean Patent Application No. 10-2010-0043643, filed on May 10, 2010, in the Korean Intellectual Property Office, the entire contents of each of which are hereby incorporated by reference in their entirety.

### BACKGROUND

1. Technical Field

The present invention relates to a blind built in a double window, and more particularly, to a blind which is installed with a simple operation structure within a double window, such that the blind is easily moved up and down. The blind installed within the double window is water-tightly sealed such that the blind is prevented from being contaminated by dust or moisture. Therefore, the blind may be used semipermanently.

2. Description of the Related Art

Generally, light shielding means, such as a blind or a vertical, is installed in windows of residential buildings, such as apartments, villas, and conventional houses, or windows of commercial buildings, such as offices and shops. Light shielding means blocks the sunlight coming into rooms through the windows, or makes the inside of the rooms invisible from the exterior.

In addition, double windows having excellent heat-insulation properties are widely used. The double window includes two glass plates spaced apart and fixed to a frame. In such a double window, an air layer is formed between two glass plates, leading to an improvement in heat-insulation properties.

Meanwhile, in the case of a typical light shielding means, such as a blind or a vertical, a guide frame is separately installed and fixed so as to support the light shielding means on a ceiling of a rear side, which is an indoor direction of an installed double window.

However, in the case where a guide frame is installed on a ceiling of a building, a ceiling portion where the guide frame is installed may be damaged. In particular, in the case where the ceiling is made of cement, a large portion of the ceiling may be damaged, which does not look good.

In addition, a specific tool, such as a drill, is required so as to install the guide frame on the ceiling having a cement and steel structure. Since an installation process is complicated, a lot of time and effort is required.

Furthermore, since the light shielding means is installed in the inside where the double window is installed, that is, the rear side, infrared light of the sun penetrates into the inside of the room and thus increases the indoor temperature. In particular, since the indoor temperature increases in the summer season, a lot of air conditioning energy may be lost. As a result, a carbon emission problem may become serious.

Moreover, since the light shielding means, such as a blind or a vertical, is always exposed, bacteria propagation and contamination problems caused by dust and moisture have been serious. Also, the exposed light shielding means has been very cumbersome.

To solve the above problems, the blind has recently been installed in the inner space of the double window. Accordingly, air conditioning energy may be saved, and bacteria propagation and contamination problems caused by dust and moisture may be prevented. As a result, hygienic environments may be provided. Environment-friendly products may be developed and fire spreading may be prevented in the event of a fire. Safety may be secured by using tempered glasses as glasses of the double window.

Therefore, in order to operate the blind installed in the inside of the double window, an electromotive blind is operated by a remote controller and a magnet-type blind is operated by a magnetic force.

However, the manufacturing cost of the electromotive blind using the remote controller is considerably high. The electromotive blind does not operate in the event of power failure. Due to frequent breakdowns, the electromotive blind has frequently received after-sales service. Therefore, the electromotive blind is inconvenient in use, and the cost of repair is incurred.

In addition, due to the limit of operation by the magnetic force, the magnet-type blind is used only when glasses have a width of 1 m or less. Therefore, the magnet-type blind may not be applied to large windows of big buildings, and thus, the use of the magnet-type blind is extremely limited. Also, when a certain time elapses, the magnetic force of the magnet is lowered and the blind may not be normally operated.

Moreover, in order to install the magnet-type blind and secure the operation space, the magnet installation area is exposed, which degrades the external appearance.

### BRIEF SUMMARY

An aspect of the present invention is directed to a sealed blind for a double window. The operation structure of the blind installed within the double window is simple, and the assembly thereof is easy. Accordingly, the manufacturing cost of the blind is reduced, and a failure rate is reduced. Also, the operation of the blind is easily controlled at the outside. The use of the blind is convenient, and a separate installation space is not required.

Another aspect of the present invention is directed to a sealed blind for a double window. The blind installed within the double window is perfectly sealed. Accordingly, bacteria propagation and contamination problems caused by dust and moisture may be solved to thereby provide hygienic environments.

According to an embodiment of the present invention, a sealed blind for a double window includes: a double window installed in a frame formed by upper, lower and side frames in which an inner glass plate and an outer glass plate are installed spaced apart by a predetermined interval; a blind installed inside the double window; an elevating shaft connected to the blind and winding the blind; a sealed rotating unit rotating the elevating shaft, wherein one side of the rotating unit is installed in the elevating shaft and the other side of the rotating unit is disposed at an outer side of the side frame of the double window, such that outside air and dust are not introduced; and an elevating wire wound around the rotating unit and operating the rotating unit.

### BRIEF DESCRIPTION OF THE SEVERAL VIEWS OF THE DRAWINGS

FIG. 1 is a cross-sectional view showing a blind installed inside a double window according to a first embodiment to the present invention.

FIG. 2 is an exploded perspective view showing the structure of the blind installed inside the double window according to the first embodiment of the present invention.

FIG. 3 is a cross-sectional view showing the double window with a built-in blind according to the first embodiment of the present invention.

FIG. 4 is a perspective view showing a rotating unit according to the first embodiment of the present invention.

FIG. 5 is a perspective view showing a state in which a pulley and an elevating wire are installed, according to the first embodiment of the present invention.

FIG. 6 is a cross-sectional view showing a state in which the pulley and the elevating wire are installed, according to the first embodiment of the present invention.

FIG. 7 is a front view showing a blind installed inside a double window, according to a second embodiment of the present invention.

FIG. 8 is an exploded perspective view showing the structure of the blind installed inside the double window, according to the second embodiment of the present invention.

FIG. 9 is a cross-sectional view showing the blind installed inside the double window, according to the second embodiment of the present invention.

FIG. 10 shows the operation of an adjusting unit according to the second embodiment of the present invention.

FIG. 11 is a perspective view showing a gear installed in a housing of a rotating unit according to the second embodiment of the present invention.

FIG. 12 is an assembled view showing a spring clutch guide of the rotating unit according to the second embodiment of the present invention.

FIG. 13 is an assembled cross-sectional view showing the rotating unit according to the second embodiment of the present invention.

FIG. 14 is a view showing the use state of the blind installed in the double window according to the second embodiment of the present invention.

### DETAILED DESCRIPTION

Exemplary embodiments of the present invention will be described below in detail with reference to the accompanying drawings. Throughout the disclosure, like reference numerals refer to like parts throughout the drawings and embodiments of the present invention.

According to an embodiment of the present invention, a sealed blind for a double window includes: a double window (10) installed in a frame formed by upper, lower and side frames (10a, 10b, 10c) in which an inner glass plate (11) and an outer glass plate (12) are installed spaced apart by a predetermined interval; a blind (20) installed inside the double window (10); an elevating shaft 31 connected to the blind (20) and winding the blind (20); a sealed rotating unit (40) rotating the elevating shaft (31), wherein one side of the rotating unit (40) is installed in the elevating shaft (31) and the other side of the rotating unit (40) is disposed at an outer side of the side frame (10c) of the double window (10), such that outside air and dust are not introduced; and an elevating wire (50) wound around the rotating unit (40) and operating the rotating unit (40).

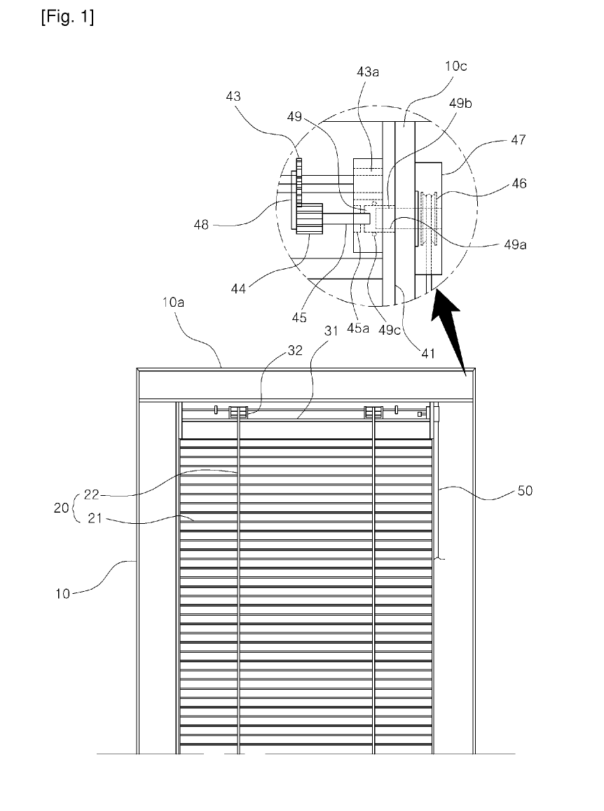

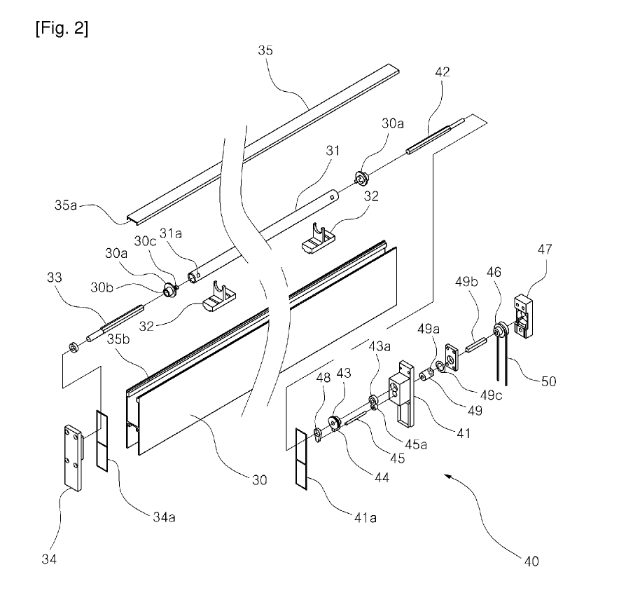

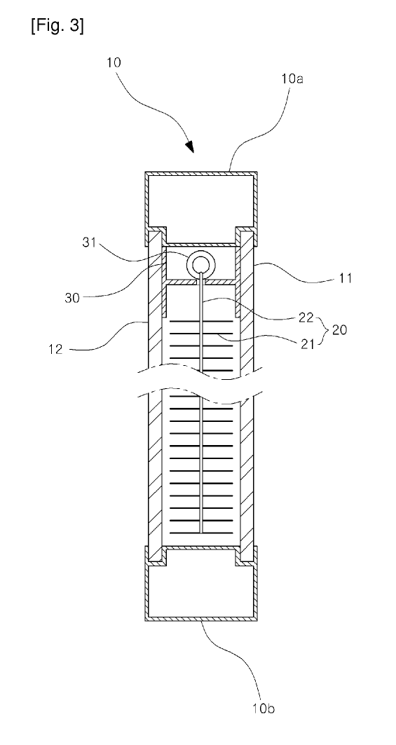

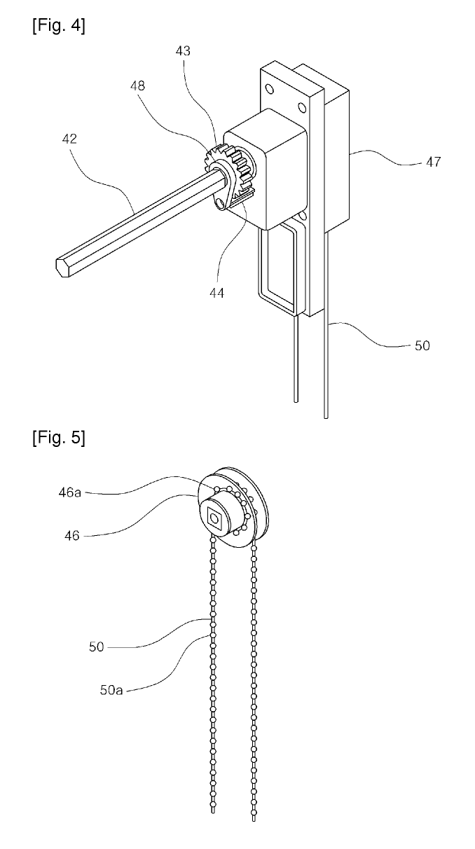

FIG. 1 is a cross-sectional view showing a blind installed inside a double window according to a first embodiment to the present invention. FIG. 2 is an exploded perspective view showing the blind of FIG. 1 which is built in the double window. FIG. 3 is a cross-sectional view showing the blind built in the double window according to the first embodiment of the present invention. FIG. 4 is a perspective view showing a coupling unit of the blind according to the first embodiment of the present invention.

As shown in FIG. 1, a blind installed inside a double window according to a first embodiment of the present invention includes a double window 10 slidably installed in a window frame, and a blind 20 installed inside the double window 10.

The double window 10 includes an inner glass plate 11 and an outer glass plate 12, which are installed spaced apart by a predetermined interval. The double window 10 has a rectangular frame shape formed by an upper frame 10a, a lower frame 10b, and a side frame 10c coupling the upper frame 10a and the lower frame 10b.

In addition, the blind 20 includes wings 21 and a ladder thread 22. The wings 21 have a predetermined width and a predetermined length and are arranged inside the double window 10 at regular intervals. The ladder thread 22 couples the wings 21 and elevates the wings 21 in a vertical direction.

In this case, an elevating bracket 30 is installed between the inner glass plate 11 and the outer glass plate 12 downwardly from the upper frame 10a of the double window 10. An elevating shaft 31 and a plurality of support brackets 32 are installed in the elevating bracket 30. The elevating shaft 31 has a pipe shape and is wound with the ladder thread 22. The plurality of support brackets 32 rotatably support the elevating shaft 31.

In addition, stoppers 30a are installed on both ends of the elevating bracket 30 to prevent the elevating bracket 30 from being released from the support brackets 32. The stopper 30a has a through-hole 30b in the center thereof. A locking protrusion 30c is formed at one end of the stopper 30a. The locking protrusion 30c is temporarily inserted into a locking hole 31a, which is formed at an end portion of the elevating shaft 31, and protrudes so that the elevating bracket 30 maintains a fixed state. The protruding end forms a locking flange. That is, when the locking protrusion 30c is pushed into the elevating shaft 31, the locking flange formed at the end of the locking protrusion 30c is inserted and fixed to the locking hole 31a by elasticity.

In this case, a cover 35 is installed on the top surface of the elevating bracket 30. An insertion section 35a is formed by bending the cover 35 along both sides of the cover 35. The insertion section 35a of the cover 35 is inserted and fixed to grooves 35b formed on the top surface of the elevating bracket 30.

In addition, the blind further includes a rotating unit 40 and an elevating wire 50. The rotating unit 40 is connected to the elevating shaft 31, and the elevating wire 50 operates the rotating unit 40.

The rotating unit 40 includes a first rotational shaft 42, a gear 43, a pinion 44, a second rotational shaft 45, and a support member 43a. The first rotational shaft 42 is rotatably installed in a bracket 41 installed at one end of the elevating bracket 30. The first rotational shaft 42 is inserted into the stopper 30a inserted into one end of the elevating shaft 31 and interlocks with the elevating shaft 31. The gear 43 is installed in the first rotational shaft 42. The number of teeth of the pinion 44 is smaller than that of the gear 43. The pinion 44 is installed in the second rotational shaft 45. The second rotational shaft 45 is rotatably installed in the bracket 41. One end of the second rotational shaft 45 protrudes to the outside of the side frame 10b. The support member 43a is installed in a through-hole of the bracket 41 to which the second rotational shaft 45 is supported.

Accordingly, when the pulley 46 is rotated by pulling the elevating wire 50, the pinion 44 coupled to the second rotational shaft 45 is interlocked, and the gear 43 engaged with the pinion 44 is also rotated. At this time, since the external diameter and the number of teeth of the pinion 44 are smaller than those of the gear 43, the gear 43 is easily rotated from the pinion 44, but the pinion 44 is not easily rotated by the gear 43 in a reverse direction.

In addition, when the gear 43 is rotated, the elevating shaft 31 is rotated with the first rotational shaft 42, and the ladder thread 22 is wound around the elevating shaft 31 or is unwound from the elevating shaft 31. Therefore, the wings 21 move up and down.

In this case, a fixing plate 48 is inserted in the middle of the first rotational shaft 42 and the second rotational shaft 45 is rotatably supported to the bracket 41. The fixing plate 48 rotatably supports the first rotational shaft 42 and the second rotational shaft 45.

In addition, a coupling pin 49 is coupled to the end of the second rotational shaft 45, and a locking groove 49a is formed on the other surface of the coupling pin 49 such that an extension shaft 49a is inserted and fixed thereto.

In order to improve sealing efficiency, an O-ring 49c is installed in the bracket 41 such that the bracket 41 is closely attached to the outer surface of the coupling pin 49. In order to further improve sealing efficiency, grease or oil is coated on the contact surface between the coupling pin 49 and the bracket 41.

Since the O-ring 49c is installed on the contact surface between the coupling pin 49 and the bracket 41 and the grease and oil are coated thereon, it is possible to prevent outside air from being introduced through a gap between the coupling pin 49 and the bracket 41. Also, in order to improve sealing efficiency, the O-ring 49c may be additionally installed.

In addition, the pulley 46 is installed at the end of the extension shaft 49b. That is, the locking groove 49a is formed in the coupling pin 49 and the extension shaft 49b is coupled thereto. The elevating bracket 30 assembled together with the coupling pin 49 as one set is installed in the double window 10, and the sealing process is performed to prevent outside air from being introduced into the double window 10. Then, the extension shaft 49b is coupled to the locking groove 49a formed in the coupling pin 49, and the pulley 46 and the cover 47 are installed. Therefore, the assembly is easily made.

This prevents outside air from being introduced into the double window 10. That is, the assembly of the elevating bracket 30 is installed inside the sealed double window 10, and the O-ring 49c is installed between the bracket 41 and the coupling pin 49 coupled to the extension shaft 49b. Thus, the sealed state is maintained. In addition, in the sealed state, only the extension shaft 49b passes through the side frame 10c and is exposed to the exterior. As a result, it is possible to perfectly prevent outside air from being introduced into the double window 10.

The support member 43a is a component for reducing a frictional force generated in the region where the first rotational shaft 42 and the second rotational shaft 45 come in contact with the bracket 41. Generally, a bearing or a bushing is used as the support member 43a.

Meanwhile, a support rotational shaft 33 is inserted into the through-hole 30b of the stopper 30a inserted into the other end of the elevating shaft 31, and the support rotational shaft 33 is rotatably fixed to a fixing bracket 34 fixed to the end of the elevating bracket 30.

In addition, packings 34a and 41a are installed between the fixing bracket 34 and the elevating bracket 30 and between the bracket 41 and the elevating bracket 30 so as to prevent foreign particles from being introduced.

Furthermore, although not shown, the blind 20 may further include a separate angle steering unit that adjusts a horizontal angle of the wings 21, just like a typical blind used in an office.

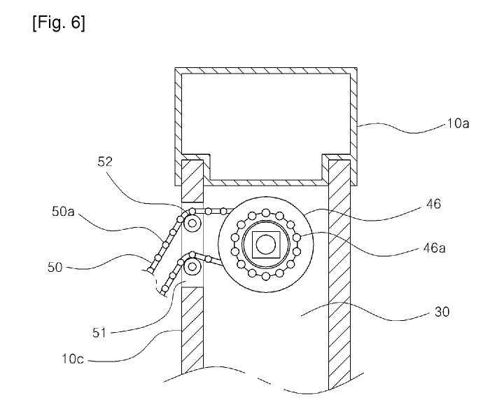

As shown in FIGS. 5 and 6, a plurality of beads 50a are installed in the elevating wire 50 at regular intervals, and a plurality of locking holes 46a are formed in the pulley 46 such that the beads 50a are temporarily held.

When the user pulls the elevating wire 50, the beads 50a are sequentially held in the locking holes 46a and therefore a frictional force is increased. As a result, the elevating wire 50 may rotate the pulley 46, without sliding on the pulley 46.

In addition, a through-hole 51 is formed in the side frame 10c, and the elevating wire 50 is exposed to the exterior through the through-hole 51. Thus, the user may easily pull the elevating wire 50.

Two guide rollers 52 are installed in the through-hole 51 to prevent the problem caused by the interference between the elevating wire 50 and the side frame 10c. The guide rollers 52 may be replaced with guide rails made of a flexible plastic material so as to prevent damages when the elevating wire 50 is guided.

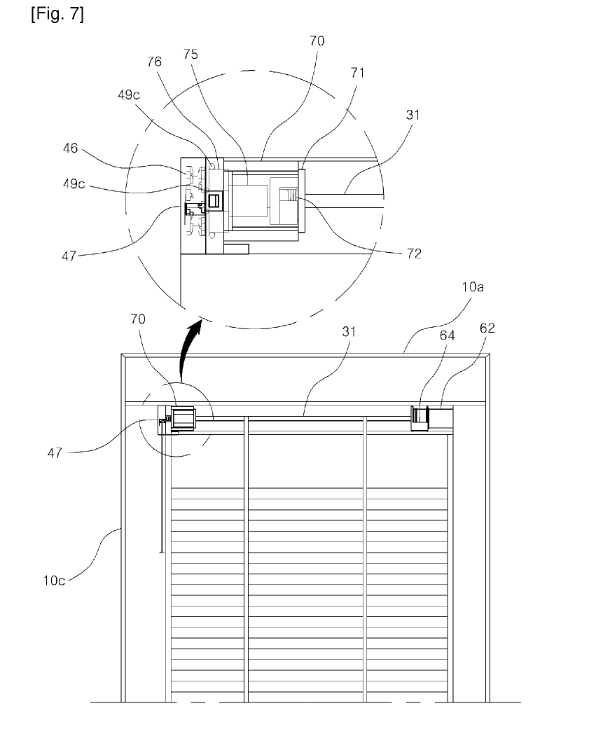

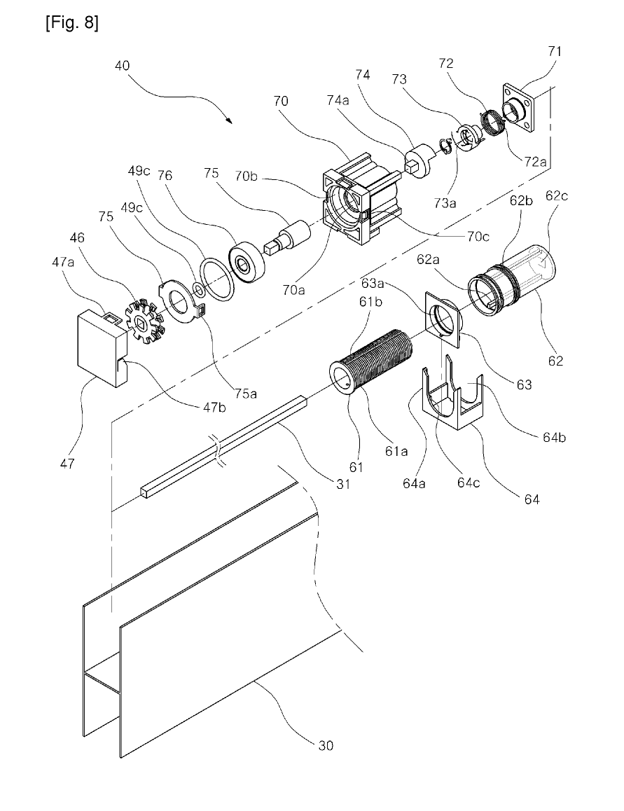

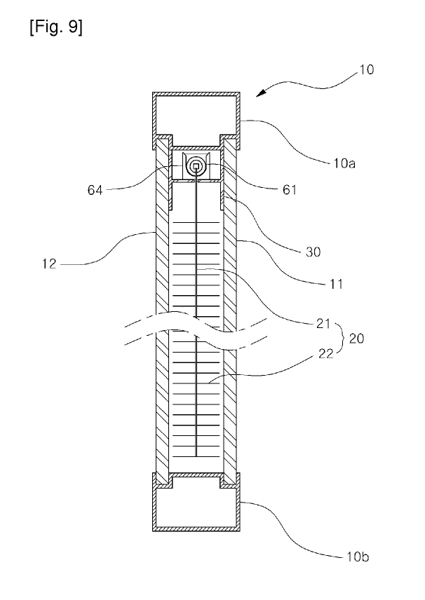

FIGS. 7 to 10 show the structure and operation of the rotating unit 40 installed in the blind built in the double window according to another embodiment of the present invention.

As shown in FIGS. 7 to 10, the double window 10 includes an inner glass plate 11 and an outer glass plate 12, which are installed spaced apart by a predetermined interval. Specifically, the inner glass plate 11 and the outer glass plate 12 are installed in a frame formed by an upper frame 10a, a lower frame 10b, and a side frame 10c. The blind 20 includes a ladder thread 21 that couples wings 22 at the inside of the double window 10 and elevates the wings 22 in a vertical direction. In order for the elevating operation of the blind 20, an elevating bracket 30 is installed in a lower portion of the upper frame 10a of the double window 10. In order to wind the ladder thread 21 of the blind 20, one side of the elevating bracket 30 is coupled to the elevating shaft 31 and the other side of the elevating bracket 30 is tightly coupled to the side frame 10c and protrudes from the side frame 10c. The rotating unit 40 is installed to perform a brake function when the blind 20 is elevated vertically while rotating the elevating shaft 31. The elevating wire 50 is installed in the protruding other side of the rotating unit 40, such that the rotating operation is performed.

A housing 70 is installed at one end of the elevating bracket 30 and has a through-hole 70a at the center thereof. Mounting sections 70b are formed on both sides of the housing 70. A spring 72, both ends 72a of which are bent, is provided to control the free fall of the blind 20 at one end of the elevating shaft 31 such that it is rotatable at the mounting section 70b formed at one side of the housing 70. A first clutch guide 73 includes an insertion pipe 73a at the center thereof. The elevating shaft 31 is inserted into the insertion pipe 73a such that the bent ends 72a of the spring 72 are locked. A second clutch guide 74 includes a shaft protrusion 74a at one end thereof. A rotational shaft 75 is installed between the first clutch guide 73 and the second clutch guide 74 and is rotatably installed in one mounting section 70b of the housing 70. The shaft protrusion 74a formed at one side of the second clutch guide 74 is inserted into the through-hole 70a of the housing 70. A rotational shaft 75, one end of which protrudes to the outside of the side frame 10c, is coupled. A bearing 76 for smooth rotation at one side of the rotational shaft 75 is installed in the other mounting section 70b of the housing 70. An O-ring 49c is inserted into the mounting section 70b where the bearing 76 is inserted, in order for sealing which prevents outside air from being introduced. A housing cover 77 is coupled for preventing the O-ring 49c and the bearing 76 from being released.

In addition, an O-ring 49c is inserted into the rotational shaft 75 protruding to the outside of the side frame 10c, in order for sealing which prevents outside air from being introduced. A pulley 46 is installed to wind the elevating wire 50 such that the rotational shaft 75 is rotated. A pulley cover 47 is coupled to the housing 70 such that the pulley 46 is wound.

In order to further sealing efficiency, greases or oil is coated on the contact surface between the rotational shaft 75 and the housing 70.

In this case, locking protrusions 70c are formed at the upper, lower, left and right sides of the housing 70. Locking sections 77a and 47a engaged with the locking protrusions 70c are formed in the housing cover 77 and the pulley cover 47. Therefore, the fitting coupling is easily achieved to prevent dust from being introduced into the bearing 76 and the pulley 46.

In addition, an inclined groove 47b is formed at one side of the pulley cover 47 to smoothly guide the operation of the elevating wire 50 wound around the pulley 46. Only the elevating wire 50 is exposed by the inclined groove 47b. Therefore, the external appearance of the blind looks good, and the use of the blind is easy because the blind is operated by pulling only the elevating wire 50.

Furthermore, a hole is formed in a portion of the side frame 10c, in which the inclined groove 47b of the pulley cover 47 is formed. A wire cover 53 is coupled to the hole of the side frame 10c. The wire cover 53 exposes only the elevating wire 50 to the outside of the double window 10. Therefore, the operation of the blind 20 may be easily manipulated at the outside, and the external appearance of the blind 20 looks good.

Moreover, although not shown, the blind 20 further includes a separate angle steering unit which adjusts a horizontal angle of the wings 22, just like the typical blind used in offices. In the angle adjustment of the wings 22, both ends 72a of the spring 72 are controlled by the clutch guides 73 and 74 and the steering unit is operated at the same time.

Therefore, when the pulley 46 is operated by pulling the elevating wire 50, the rotational shaft 75 coupled to the pulley 46 is rotated. The first clutch guide 73 and the second clutch guide 74 coupled to the elevating shaft 31 are rotated at the same tie. The ladder thread 21 of the blind 20 wound around the elevating shaft 31 is wound or unwound. Accordingly, the wings 22 move upward and downward. The spring 72 coupled between the first clutch guide 73 and the second clutch guide 74 is elastically operated. When the spring 72 is elastic to some degree, the upward and downward movement of the blind 20 is controlled.

Since the O-rings 49c are installed on the contact surface between the housing 70 and the bearing 76 and the contact surface between the rotational shaft 75 and the pulley 46, and the grease and oil are coated thereon, it is possible to prevent outside air from being introduced through a gap therebetween. Also, the rotational operation is smoothly performed.

When the sealing treatment is completed between the housing 70 and the side frame 10c installed together with the elevating bracket 30, the pulley 46 and the pulley cover 47 are installed at the end of the rotational shaft 75 protruding to the outside of the side frame 10c. Accordingly, it is possible to further prevent outside air from being introduced into the double window.

Meanwhile, a control unit 60 is installed at the other side of the elevating shaft 31 to control the upward/downward movement of the blind 20 and the angle of the wings 22.

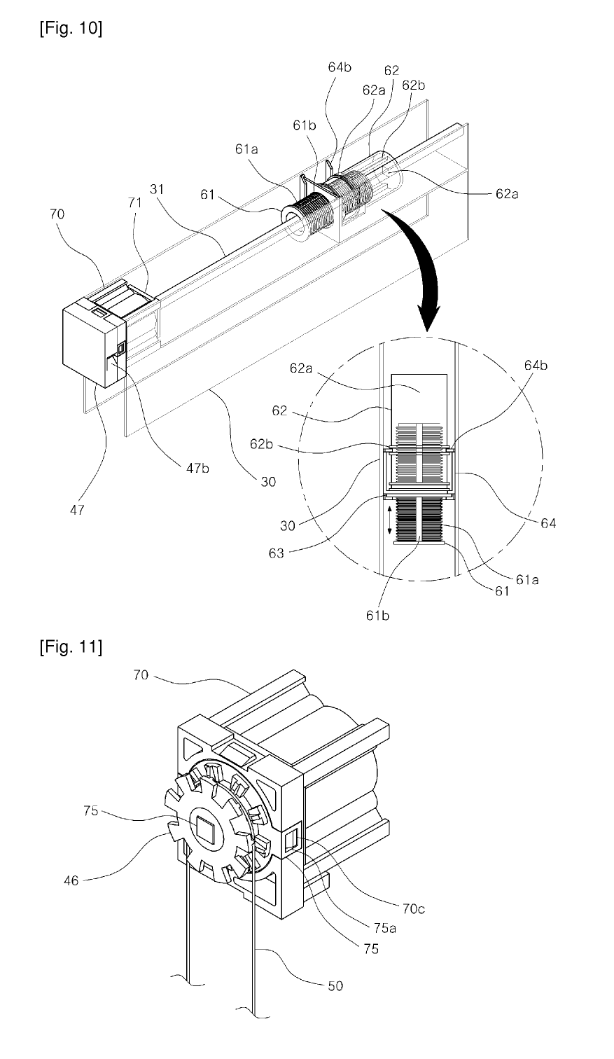

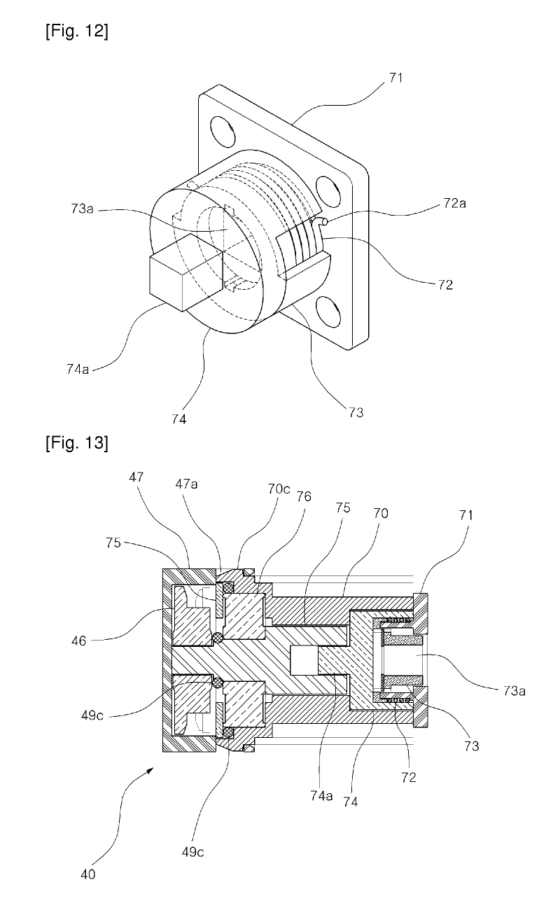

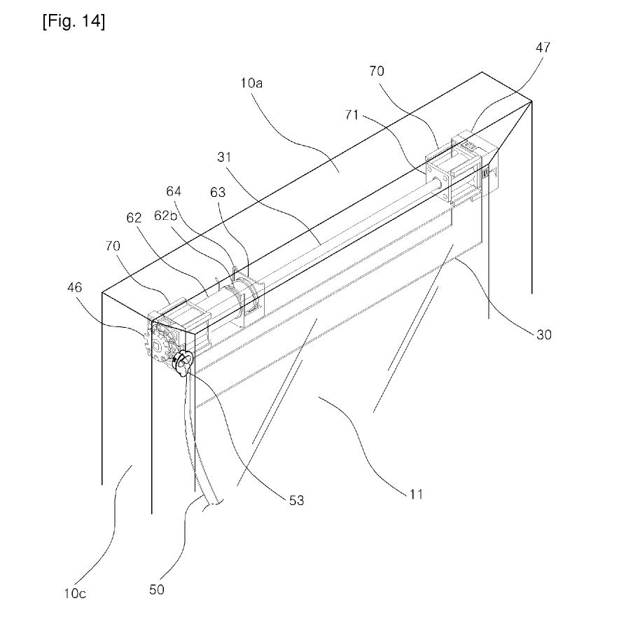

As shown in FIG. 10, the control unit 60 includes a screw 61 having a pipe shape. The screw 61 includes a spiral section 61a and guide grooves 61b. The spiral section 61a is formed at the outer surface of the control unit 60. The guide grooves 61b are symmetrically formed in upper and lower portions of the control unit 60. A screw nut 63 includes a spiral protrusion 63a engaged with the spiral section 61a of the screw 61. A tilt guide pipe 62 includes a guide protrusion 62a engaged with the guide groove 61b of the screw 61 inwardly. The screw 61, the screw nut 63, and the tilt guide pipe 62 are coupled to the elevating shaft 31. When the elevating shaft 31 is rotated by the rotating unit 40, the tilt guide pipe 62 is rotated at the same time. Accordingly, the screw 61 is adjusted forward or backward by the guide protrusion 62a of the tilt guide pipe 62 and the spiral protrusion 63a of the screw nut 63.

In addition, insertion grooves 63c having the same shape are formed at one side of the tilt guide pipe 62 such that the polygonal elevating shaft 31 is inserted and rotated.

The screw guide 64 is installed in the elevating bracket 30 to rotatably support the control unit 60. In the screw guide 64, a protrusion section 64b is formed at an edge such that a seating section 64a is formed at the center. Seating protrusions 62b are symmetrically formed in the tilt guide pipe 62 at a constant interval such that they are inserted into the protrusion section 64 disposed in the rear side. A partition wall 64c is formed at the rear side of the protrusion section 64b such that the screw nut 63 is inserted into the protrusion section 64b disposed in the front side. The control unit 60 is inserted and fixed between the protrusion section 64b and the partition wall 64c.

Therefore, since the screw nut 63 and the tilt guide pipe 62 are inserted into the screw guide 64, and the screw nut 63 is fixed and only the tilt guide pipe 62 is rotated at the screw guide 64 by the seating protrusion 62b.

Meanwhile, the rotating unit 40 and the control unit 60 protrude the elevating shaft 31 to one side toward the side frame 10c according to the installation of the double window 10. The protruding section is sealed. Then, the pulley 46 is installed. The present invention is not limited to one side. Both sides may be used according to the installation.

In this case, the elevating shaft 31 is formed in a polygonal shape. The insertion grooves 63a and 73a having the same shape as the elevating shaft 31 are formed in the control unit 60 and the rotating unit 40 installed in the elevating shaft 31. When the polygonal elevating shaft 31 is inserted between the control unit 60 and the rotating unit 40 of the blind 20 and is rotated, the elevating shaft 31 is not idling and is rotated at the same time.

Therefore, in the blind 20 built in the double window 10 according to the embodiment of the present invention, the blind 20 is installed between the inner glass plate 11 and the outer glass plate 12. The angle of the wings 22 of the blind 20 is adjusted while the wings 22 are elevated inside the double window 10. Accordingly, light incident into the inside of the room is blocked, or the inside of the room is shielded. The elevating wire 50 is easily manipulated at the outside of the double window 10. The blind 20 is prevented from being contaminated by dust and moisture.

As described above, according to exemplary embodiments of the present invention, a separate installation space for installation of the blind in the double window is not required. Accordingly, the installation of the blind is easy. Since the blind is installed inside the double window, the blind is not cumbersome, improving an aesthetic feeling. Furthermore, since the blind is sealed inside the double window, the blind is prevented from contamination and bacteria propagation caused by dust or the like.

Moreover, the upward/downward operation of the blind installed inside the double window is easily manipulated at the outside of the double window. Accordingly, the blind is exactly operated and controlled, improving the convenience of use.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A sealed blind for a double window, comprising:
a double window installed in a frame formed by upper, lower and side frames in which an inner glass plate and an outer glass plate are installed spaced apart by a predetermined interval;
a blind installed inside the double window;
an elevating shaft connected to the blind and configured to wind and unwind the blind;
a sealed rotating unit configured to rotate the elevating shaft, a first side of the rotating unit being installed in the elevating shaft and a second side of the rotating unit being disposed at an outer side of the side frame of the double window, such that outside air and dust are not introduced; and
an elevating wire wound around the rotating unit and configured to operate the rotating unit.

2. The sealed blind for a double window according to claim 1, wherein:
an elevating bracket in which the elevating shaft and the rotating unit is installed is provided inside the upper, lower and side frames of the double window; and
a plurality of support brackets rotatably supporting the elevating shaft are coupled to the elevating bracket.

3. The sealed blind for a double window according to claim 1, wherein the rotating unit comprises:
a first rotational shaft coupled to one side of the elevating shaft and rotatably supported to the support bracket;
a gear installed in the first rotational shaft;
a pinion having a smaller number of teeth than the gear;
a second rotational shaft including an end that protrudes to the outside of the side frame; and
a pulley installed at the end of the second rotational shaft and configured to wind and unwind the elevating wire.

4. The sealed blind for a double window according to claim 3, wherein:
a coupling pin is coupled between the second rotational shaft and the pulley, one side of the coupling pin being coupled to the second rotational shaft, a locking groove being formed on the other surface of the coupling pin; and
one end of an extension shaft is inserted and fixed to the locking groove formed in the coupling pin, and the pulley is installed in the other end of the extension shaft.

5. The sealed blind for a double window according to claim 1, wherein:
a plurality of beads are installed in the elevating wire at regular intervals; and
a plurality of locking holes are formed in the pulley such that the beads are temporarily held.

6. The sealed blind for a double window according to claim 2, wherein:
a bracket is installed in the elevating bracket to rotatably support the first rotational shaft, the second rotational shaft, and the coupling pin;
at least one O-ring is installed on a contact surface between the coupling pin and the bracket to improve sealing efficiency; and
a support member is installed in a through-hole of the bracket, to which the first rotational shaft and the second rotational shaft are supported, to reduce a frictional force between the first rotational shaft and the second rotational shaft.

7. The sealed blind for a double window according to claim 6, wherein the support member comprises a bushing and a bearing.

8. The sealed blind for a double window according to claim 6, wherein a packing is installed on a contact surface between the bracket and the elevating bracket to prevent foreign particles from being introduced.

9. The sealed blind for a double window according to claim 2, wherein:
a support rotational shaft is installed at one end of the elevating shaft and is rotatably coupled to a locking bracket fixed to the elevating bracket; and
the support rotational shaft is coupled to a stopper having a through-hole into which the first rotational shaft coupled at the other end is inserted.

10. The sealed blind for a double window according to claim 9, wherein a packing is installed on a contact surface between the locking bracket and the elevating bracket to prevent foreign particles from being introduced.

11. The sealed blind for a double window according to claim 9, wherein:
the stopper has a cylindrical shape in which the through-hole is formed; and
a locking protrusion is formed at one end of the stopper such that the locking protrusion is temporarily inserted into a locking hole formed at an end of the elevating shaft.

12. The sealed blind for a double window according to claim 1, wherein the side frame includes a through-hole through which the elevating wire is exposed toward the front side of the double window.

13. The sealed blind for a double window according to claim 12, wherein a guide roller is installed in the through-hole to prevent the damage of the elevating wire which is caused when the elevating wire interferes with the side frame while passing through the through-hole.

14. The sealed blind for a double window according to claim 1, wherein:
a control unit is installed in the other side of the elevating shaft, in which the rotating unit is installed, and functions to control upward/downward movement of the blind and control an angle of the blind;
an O-ring is installed in the rotating unit and the control unit to prevent outside air from being introduced into the double window; and
the control unit and the O-ring are assembled and sealed by a sealing treatment.

15. The sealed blind for a double window according to claim 14, wherein:
the elevating shaft is formed in a polygonal shape; and
insertion grooves having the same shape as the elevating shaft are formed in the rotating unit and the control unit installed in both sides of the elevating shaft, so that the elevating shaft is not idling when rotating.

16. The sealed blind for a double window according to claim 14, wherein:
a housing has a through-hole at the center thereof and has mounting sections on both sides thereof;
a spring, both ends of which are bent, is provided to control the free fall of the blind at one end of the elevating shaft such that the spring is rotatable at the mounting section formed at one side of the housing;
a first clutch guide includes an insertion pipe at the center thereof, such that the elevating shaft is inserted into the insertion pipe and the bent ends of the spring are locked;
a second clutch guide includes a shaft protrusion at one end thereof;
a rotational shaft is installed between the first clutch guide and the second clutch guide and is rotatably installed in the mounting section provided at one side of the housing;
a shaft protrusion formed at one side of the second clutch guide is inserted into the through-hole of the housing;
a rotational shaft, one end of which protrudes to the outside of the side frame, is coupled;
a bearing for smooth rotation at one side of the rotational shaft is installed in the other mounting section of the housing;
an O-ring is inserted into the mounting section where the bearing is inserted, in order for sealing which prevents outside air from being introduced; and
a housing cover is coupled for preventing the O-ring and the bearing from being released.

17. The sealed blind for a double window according to claim 16, wherein:
an O-ring is inserted into the rotational shaft protruding to the outside of the side frame, in order to form a seal which prevents outside air from being introduced;
a pulley is installed to wind the elevating wire 50 while the rotational shaft is rotated; and
a pulley cover protecting the pulley is coupled to the housing.

18. The sealed blind for a double window according to claim 16, wherein:
locking protrusions are formed at upper, lower, left and right sides of the housing; and
locking sections engaged with the locking protrusions are formed in the housing cover.

19. The sealed blind for a double window according to claim 22, wherein an inclined groove is formed at one side of the pulley cover smoothly guide the operation of the elevating wire wound around the pulley.

20. The sealed blind for a double window according to claim 19, wherein:
a hole is formed in the side frame, in which the inclined groove of the pulley cover is formed;
a wire cover is coupled to the hole of the side frame; and
the wire cover exposes only the elevating wire to the outside of the double window, such that the external appearance of the blind looks good and the operation of the blind is easily manipulated.

21. The sealed blind for a double window according to claim 15, wherein:
the control unit includes a screw having a pipe shape;
the screw includes a spiral section and guide grooves;
the spiral section is formed at the outer surface of the control unit;
the guide grooves are symmetrically formed in upper and lower portions of the control unit;
a screw nut includes a spiral protrusion engaged with the spiral section of the screw;
a tilt guide pipe includes a guide protrusion engaged with the guide groove of the screw inwardly;
the screw, the screw nut, and the tilt guide pipe are coupled to the elevating shaft;
when the elevating shaft is rotated, the tilt guide pipe rotated at the same time; and
the screw is moved forward or backward by the guide protrusion of the tilt guide pipe and the spiral protrusion of the screw nut, so that the upward/downward movement of the blind and the angle of the blind are controlled.

22. The sealed blind for a double window according to claim 17, wherein:
locking protrusions are formed at upper, lower, left and right sides of the housing; and
locking sections engaged with the locking protrusions are formed in the pulley cover.
